(19) United States
(12) Patent Application Publication
(10) Pub. No.: US 2003/0174447 A1
(43) Pub. Date: Sep. 18, 2003

(54) Spin valve type magnetoresistive element

(75) Inventors: Seong-Rae Lee, Seoul (KR); Ho-Gun Cho, Busan (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Korea Chungangeducational Foundation, Seoul (KR)

(21) Appl. No.: 10/336,486

(22) Filed: Jan. 3, 2003

(30) Foreign Application Priority Data
Mar. 12, 2002 (KR) 2002-13249

(51) Int. Cl. G11B 5/39

(52) U.S. Cl. 360/324.1

(57) ABSTRACT

A spin valve type magnetoresistive element includes a substrate, an under layer deposited on the substrate, and a sensor portion arranged on the under layer. The under layer is formed of an amorphous CoNbZr alloy. The sensor portion includes a first ferromagnetic layer in which a magnetizing direction is changed by application of a magnetic field, a second ferromagnetic layer in which a magnetizing direction is fixed, a spacer layer which is non-magnetic and arranged between the first ferromagnetic layer and the second ferromagnetic layer, and an antiferromagnetic layer which is arranged to be adjacent to the second ferromagnetic layer to fix the magnetizing direction of the second ferromagnetic layer.

### FIELD OF THE INVENTION

The present invention relates to a spin valve type magnetoresistive element, and more particularly, to a spin valve type magnetoresistive element having an improved structure in which reduction of major features such as a magnetoresistive ratio or an exchange coupled field can be effectively prevented when it is heated to a high temperature.

### BACKGROUND

A spin valve type magnetoresistive element is widely adopted in a magnetic sensor for reading magnetic information stored in a magnetic recording medium such as a hard disk, for example. As it is known well, the spin valve type magnetoresistive element reads magnetic information from a magnetic recording medium by using a magnetoresistance changing due to a difference in scattering of conductive electrons by a difference in a relative magnetizing direction between neighboring ferromagnetic layers. Various kinds of the spin valve type magnetoresistive elements have already been widely known.

FIG. 1 shows an example of a conventional spin valve type magnetoresistive element. Referring to the drawing, a conventional spin valve type magnetoresistive element 9 has a structure in which an under layer 2, a first ferromagnetic layer, a spacer layer 4, a second ferromagnetic layer 5, an antiferromagnetic layer 6, and a capping layer 7 are sequentially deposited over a substrate 1 such as a semiconductor wafer. The under layer 2 is formed of tantalum (Ta). The first ferromagnetic layer 3 is formed of a ferromagnetic material such as a CoFe alloy and also referred to as a free layer which can change a magnetizing direction by an applied magnetic field. The spacer layer 4 is formed of a nonmagnetic material such as copper (Cu) and has a function to separate the first ferromagnetic layer 3 from the second ferromagnetic layer 5. The second ferromagnetic layer 5 is formed of a ferromagnetic material such as a CoFe alloy and also referred to as a pinned layer. The antiferromagnetic layer 6 is typically formed of an alloy including Mn, for example, an IrMn alloy, a FeMn alloy, a PtMn alloy, and a NiMn alloy and has a function to fix the magnetizing direction of the second ferromagnetic layer 5. The antiferromagnetic layer 6, together with the first ferromagnetic layer 3, the spacer layer 4, and the second ferromagnetic layer 5, constitutes a sensor portion for reading magnetic information. The capping layer 7 has a function to protect the layers disposed thereunder and is formed of a Ta material.

When a magnetic field is applied to the spin valve type magnetoresistive element 9 having the above structure, the magnetizing direction of the first ferromagnetic layer 3 with respect to the magnetizing direction of the second ferromagnetic layer 5 changes. As a result, magnetoresistance between the first and second ferromagnetic layers 3 and 5 changes so that magnetic information stored in a magnetic recording medium can be detected by means of a change in the magnetoresistance. Thus, since the magnetic information of the magnetic recording medium is detected by a change in magnetoresistance between the first and second ferromagnetic layers 3 and 5, a magnetoresistive ratio (an MR ratio: an amount of a change in magnetoresistance with respect to the minimum magnetoresistance) and an exchange coupled field (Hex: a force that the antiferromagnetic layer fixes the magnetizing direction of the second ferromagnetic layer) are needed to be stably maintained when a magnetoresistive element is used.

In the meantime, heat at a high temperature is applied to the magnetoresistive element when a magnetic sensor such as a magnetic head for a hard disk drive is manufactured and in use. For example, the magnetic sensor being used is typically heated to a temperature of about 150° by a working current and reaches a higher temperature when it is instantaneously overheated. Also, during manufacture of the magnetic sensor, heat at a higher temperature than that applied in use is applied. When the magnetoresistive element is heated, motion of atoms becomes more active so that interdiffusion or intermixing between atoms between the neighboring layers happens. As it is well known, the interdiffusion or intermixing is greatly affected by the coarseness of a boundary surface and the size of a crystal grain of each layer of the magnetoresistive element, so that major features such as a magnetoresistive ratio or an exchange coupled field are deteriorated by the interdiffusion or intermixing.

However, in the magnetoresistive element 9 having the conventional structure, when it is heated, the interdiffusion and intermixing happen very actively so that the amount of reduction of the major features such as a magnetoresistive ratio or an exchange coupled field increases very greatly. Accordingly, magnetic information may not be accurately detected. In particular, in the case of a high density magnetic recording medium, since the magnetic field applied from the magnetic recording medium decreases, the above-described problems become serious.

Therefore, the development of a magnetoresistive element having a structure in which the magnetoresistive ratio or exchange coupled field is not greatly reduced when the magnetoresistive element is heated is needed.

### SUMMARY

To solve the above-described problems, it is an object of the present invention to provide a spin valve type magnetoresistive element having an improved structure in which reduction of major features such as a magnetoresistive ratio or an exchange coupled field can be effectively prevented when it is heated to a high temperature.

To achieve the above object, there is provided a spin valve type magnetoresistive element comprising a substrate, an under layer deposited on the substrate, and a sensor portion arranged on the under layer. The under layer is formed of an amorphous CoNbZr alloy. The sensor portion comprises a first ferromagnetic layer in which a magnetizing direction is changed by application of a magnetic field, a second ferromagnetic layer in which a magnetizing direction is fixed, a spacer layer which is non-magnetic and arranged between the first ferromagnetic layer and the second ferromagnetic layer, and an antiferromagnetic layer which is arranged to be adjacent to the second ferromagnetic layer to fix the magnetizing direction of the second ferromagnetic layer.

### BRIEF DESCRIPTION OF THE DRAWINGS

The above object and advantages of the present invention will become more apparent by describing in detail preferred embodiments thereof with reference to the attached drawings in which:

FIG. 1 is a view showing the structure of an example of a conventional spin valve type magnetoresistive element;

FIG. 2 is a view showing the structure of a spin valve type magnetoresistive element according to a preferred embodiment of the present invention;

FIG. 3A is a 3-D image showing the state of a surface of an under layer of the conventional magnetoresistive element;

FIG. 3B is a 3-D image showing the state of a surface of an under layer of the magnetoresistive element according to a preferred embodiment of the present invention;

FIG. 4A is an image showing the structure of each layer in the conventional magnetoresistive element;

FIG. 4B is an image showing the structure of each layer in the magnetoresistive element according to a preferred embodiment of the present invention;

FIG. 5 is a graph showing the relationship between the magnetoresistive ratio and the exchange coupled field measured after the conventional magnetoresistive element is heat-processed at 300° C.;

FIG. 6 is a graph showing the relationship between the magnetoresistive ratio and the exchange coupled field measured after the magnetoresistive element according to the present invention is heat-processed at 300° C.;

FIG. 7 is a graph showing the gradient of the magnetoresistive ratio and the exchange coupled field measured after the magnetoresistive element according to the present invention is heat-processed at 300° C.; and

FIG. 8 is a graph for explaining an effect by the capping layer having various thickness in the magnetoresistive element according to the present invention.

### DETAILED DESCRIPTION OF THE PREFERRED EMBODIMENTS

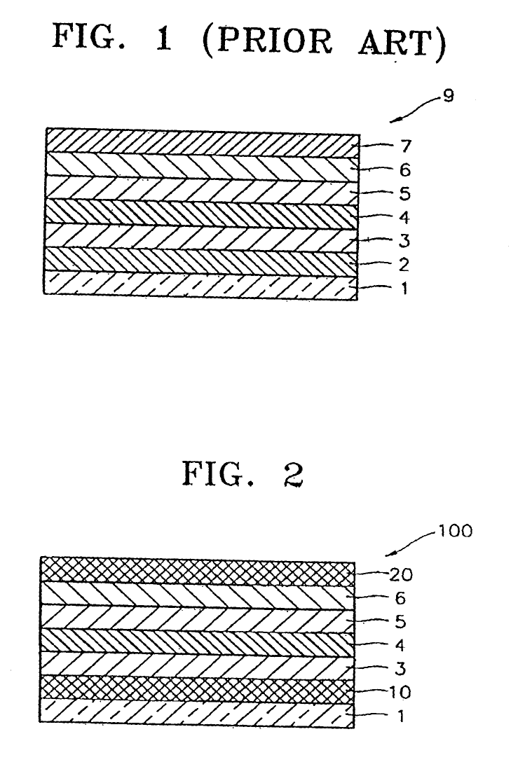

FIG. 2 shows a spin valve type magnetoresistive element according to a preferred embodiment of the present invention. Referring to the drawing, a magnetoresistive element 100 according to a preferred embodiment of the present invention, like the conventional magnetoresistive element 9 shown in FIG. 1, includes an under layer 10, a first ferromagnetic layer 3, a spacer layer 4, a second ferromagnetic layer 5, an antiferromagnetic layer 6, and a capping layer 20, which are sequentially deposited over a substrate 1. The first ferromagnetic layer 3, the spacer layer 4, the second ferromagnetic layer 5, and the antiferromagnetic layer 6 constitute a sensor portion for reading magnetic information from a magnetic recording medium. Since the basic functions of the respective layers 10, 3, 4, 5, 6, and 20 are the same as those of the respective layers 2, 3, 4, 5, 6, and 7 of the magnetoresistive element 9 shown in FIG. 1, detailed descriptions thereof will be omitted herein.

Unlike the conventional magnetoresistive element 9 described with reference to FIG. 1 which includes the under layer 2 formed of a Ta material, it is a characteristic feature of the present invention that the under layer 10 of the magnetoresistive element 100 of the present preferred embodiment is formed of an amorphous CoNbZr alloy. Here, the capping layer 20 is preferably formed of an amorphous CoNbZr alloy and the antiferromagnetic layer 6 is preferably formed of an alloy including Mn, for example, an IrMn alloy, a FeMn alloy, or a NiMn alloy.

In the magnetoresistive element 100 having the above structure, since the under layer 10 is formed of an amorphous CoNbZr alloy which is crystallized at a high temperature approximately over 500° C., the under layer 10 is thermally stable and the layers sequentially deposited over the under layer 10 have a fine and dense structure. Also, the under layer 10 formed of an amorphous CoNbZr alloy has a very even surface compared to the under layer formed of Ta, so that the boundary surfaces of the respective layers deposed thereon are even. Thus, when the magnetoresistive element 100 of the present preferred embodiment is heated to a high temperature, interdiffusion or intermixing of atoms at each of the boundary surfaces is prevented. As a result, since the deterioration of a magnetic feature of each layer is prevented, the major features such as a magnetoresistive ratio or an exchange coupled field are not deteriorated too much.

The above results are supported through various experiments performed by the subject inventor. The present invention is described in detail based on the results of the above experiments.

A plurality of samples (hereinafter, referred to as a “first sample”) of the conventional magnetoresistive element 9 having the under layer 2 and the capping layer 7 which are formed of a Ta material, as shown in FIG. 1, and a plurality of samples (hereinafter, referred to as a “second sample”) of the magnetoresistive element 100 having the under layer 10 and the capping layer 20 which are formed of an amorphous CoNbZr alloy, as shown in FIG. 2, are manufactured.

An RF magnetron sputtering apparatus is used as a sputtering apparatus for manufacture of the respective sample, and a silicon wafer having an oxide film having a thickness of about 2,000 Å formed on the surface thereof is used as the substrate 1. Co90Fe10 is used as a target for deposition of the first ferromagnetic layer 3 and the second ferromagnetic layer 5. Cu is used as a target for deposition of the spacer layer 4. Ir21Mn79 is used as a target for deposition of the antiferromagnetic layer 6. Ta is used as a target for deposition of the under layer 2 and the capping layer 7 of the first sample. Amorphous Co85.5Nb8Zr6.5 is used as a target for deposition of the under layer 10 and the capping layer 20 of the second sample. The purity of the respective targets are all over 99.95% and an Ar gas having purity over 99.9999% is used as a sputtering gas. A degree of the initial vacuum before deposition is set to be less than 5×10−7 Torr, electric power for deposition is 50-130 W, and a magnetic field of about 500 Oe for anisotropy of the respective layers is applied. In the respective samples, the thickness of each of the first ferromagnetic layer 3 and the second magnetic layer 5 is about 3 nm, the thickness of the spacer layer 4 is about 2.5 nm, and the thickness of the antiferromagnetic layer 6 is about 7.5 nm. The thickness of each of the under layer 2 and the capping layer 7 formed of a Ta material in the first sample is about 5 nm, and the thickness of each of the under layer 10 and the capping layer 20 formed of an amorphous CoNbZr alloy in the second sample is about 2 nm.

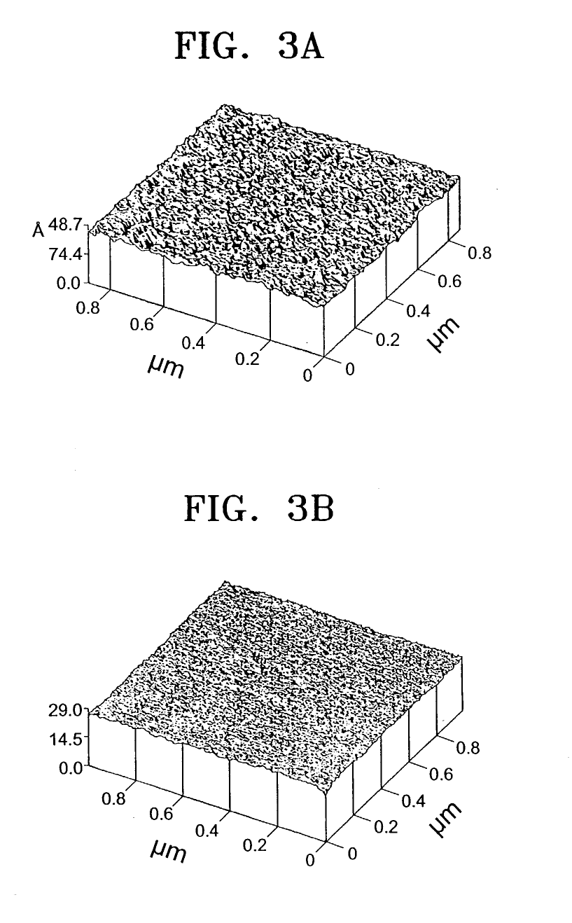

According to the results of measurement of the surfaces of the under layers 2 and 10 of the first and second samples manufactured as above, the surface of the under layer 2 of the first sample is coarse and rough as shown in FIG. 3A while the surface of the under layer 10 of the second sample is smooth and even, as shown in FIG. 3B, compared to the under layer 2 of the first sample. As a result, it is easy to expect that the surface coarseness (the difference in height between the highest protruding portion and the lowest sunken portion at each surface) of each of the layers deposited over the under layer 10 of the second sample is remarkably less than that of each layer deposited over the under layer 2 of the first sample. This is supported by the results of measurement of coarseness of a surface of each of the layers of the first and second samples which is performed by the subject inventor. The results of the measurement are listed in Table 1. The unit of figures in Table 1 is Å.

TABLE 1

| | | First | | Second | | |
|---|---|---|---|---|---|---|
| | | ferro- | | ferro- | Antiferro- | |
| | Under | magnetic | Spacer | magnetic | magnetic | Capping |
| | layer | layer | layer | layer | layer | layer |
| First | 0.432 | 0.226 | 0.227 | 0.250 | 0.264 | 0.251 |
| Sample | | | | | | |
| Second | 0.07 | 0.095 | 0.17 | 0.12 | 0.15 | 0.16 |
| Sample | | | | | | |

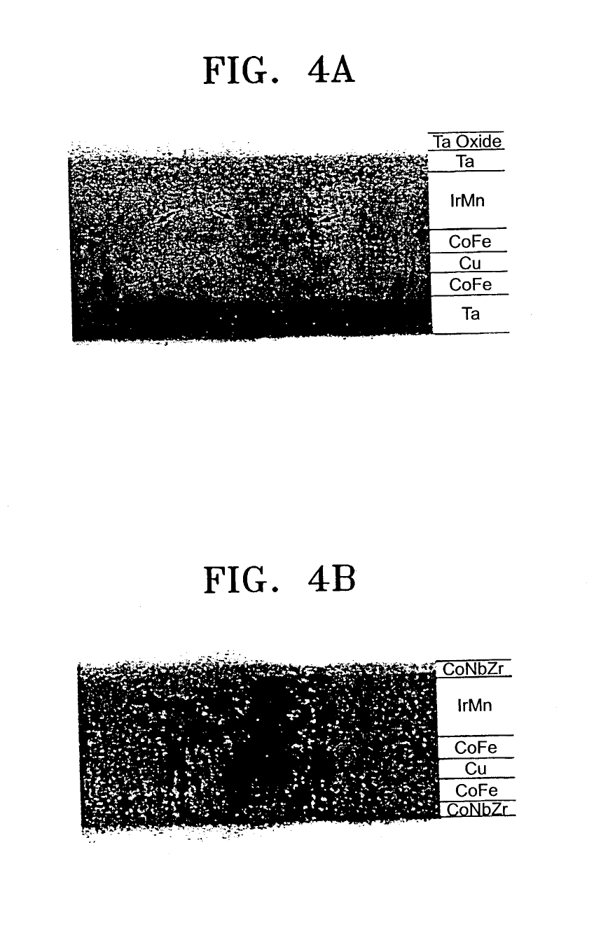

Also, in the structure of each layer of the first and second samples, it can be seen that the layers deposited over the under layer 2 formed of a crystalline Ta material have a columnar structure in which diffusive motion of atoms is relatively freer, as shown in FIG. 4A. The layers deposited over the under layer 10 formed of an amorphous CoNbZr alloy have a fine and dense structure in which the diffusive motion of atoms is not easy, as shown in FIG. 4B.

The subject inventor tested various heat treatment experiments with respect to the above first and second samples.

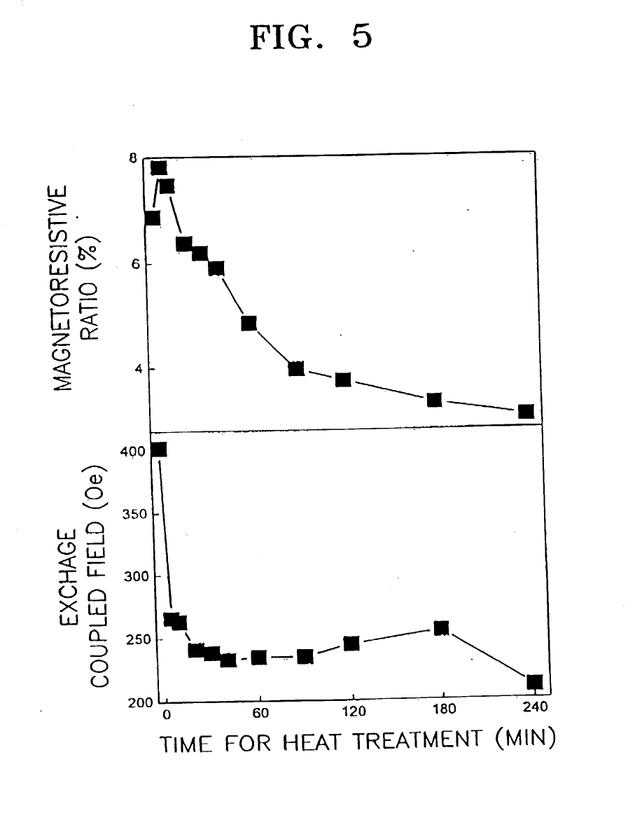

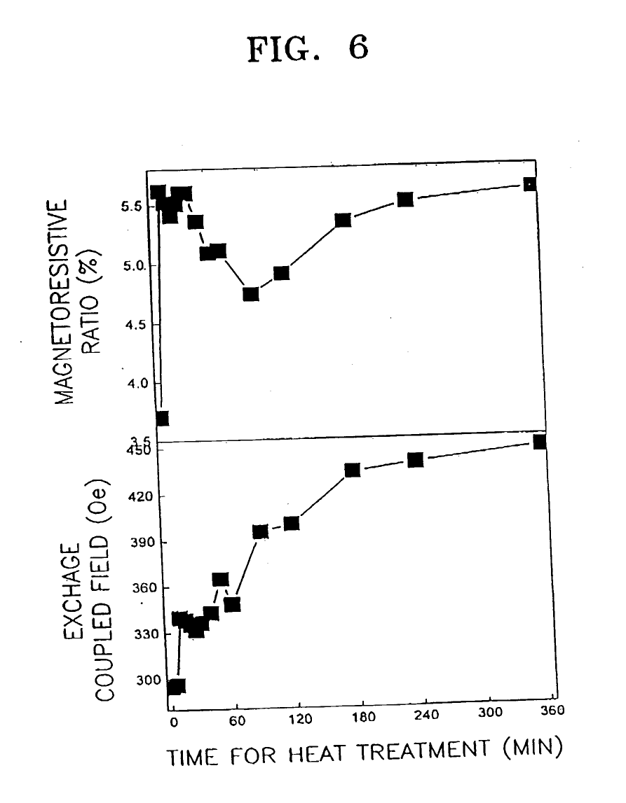

First, heat treatment is performed to each of several first and second samples at a temperature of 300° C. for different periods. Then, a magnetoresistive ratio and an exchange coupled field of each of the first and second samples are measured at the room temperature. The results of the experiments with respect to the first samples are shown in FIG. 5 and those of the second samples are shown in FIG. 6.

As shown in FIG. 5, in the case of the first sample which is not heat-treated (the first sample for which the heat treatment time is 0), the magnetoresistive ratio is about 7% and the exchange coupled force is about 400 Oe. In the case of the first sample which is heat-treated for 10 minutes, the magnetoresistive ratio is about 8% which is slightly greater than that of the first sample which is not heat-treated and the exchange coupled field is about 260 Oe which is drastically reduced compared to that of the first sample which is not heat-treated. In the case of the first samples which are heat-treated for more than 20 minutes, the magnetoresistive ratios decrease as the heat treatment time of the samples increases, so that the magnetoresistive ratio of the first sample which is heat-treated for 240 minutes is reduced to merely about 2%. The reason why the magnetoresistive ratio is drastically reduced is mainly because of the interdiffusion and intermixing between atoms between the respective layers. Additionally, Mn of the antiferromagnetic layer 6 is diffused toward the second ferromagnetic layer 5 so that a magnetic feature at the boundary surface is deteriorated. Also, the exchange coupled fields of the first samples which are heat-treated for more than 20 minutes are all less than those of the first sample which is heat-treated for 10 minutes. Meanwhile, in FIG. 5, a phenomenon that the magnetoresistive ratio of the first sample which is heat-treated for 10 minutes is rather greater than that of the first sample which is not heat-treated is because stress or defects remaining in each of the layers of the first sample generated in the manufacturing process thereof are removed during heat treatment for a short time so that chemical stability at each boundary surface is improved.

In the case of the second samples, as shown in FIG. 6, the magnetoresistive ratio and the exchange coupled field of the second sample which is not heat-treated (the second sample for which a heat treatment time is 0) is about 3.7% and 300 Oe, respectively, which are lower than those of the first sample which is not heat-treated. However, the second samples which are heat-treated exhibit a magnetoresistive ratio (about 4.7% or more, or about 5.6% when heat treatment is performed for 240 minutes) and an exchange coupled field (about 330 Oe or more, or about 450 Oe when heat treatment is performed for 240 minutes) which are drastically improved compared to the second sample which is not heat-treated. Also, the second samples which are heat-treated have an exchange coupled field greater than that of the first samples which is heat-treated. As a whole, a second sample receiving a heat treatment for a longer time exhibits a greater exchange coupled field. For the magnetoresistive ratio, unlike the first samples in which the magnetoresistive ratios thereof decrease as they are heat-treated for a longer time, it is shown that the second samples all have stable magnetoresistive ratios over about 5%, except for a case of receiving heat-treatment for about 60-120 minutes. In FIG. 6, the reason why the magnetoresistive ratio of the second sample which is heat-treated for 10 minutes is greater than that of the second sample which is not heat-treated is the same as that for the case in which the magnetoresistive ratio of the first sample which is heat-treated for 10 minutes is greater than that of the first sample which is not heat-treated. Meanwhile, the magnetoresistive ratios of the second samples which is heat-treated for 5-90 minutes decrease as the time for heat treatment is prolonged. This is a typical phenomenon produced by the interdiffusion and intermixing between atoms at the boundary surface at each layer as kinetic energy of the atoms in each layer is increased by the initial high temperature.

However, it can be seen that the magnetoresistive ratios of the second samples which are heat-treated for more than 90 minutes rather increase as the time for heat treatment is prolonged. This phenomenon is due to the capping layer 20 of the second sample formed of an amorphous CoNbZr alloy. In detail, most Mn atoms of the antiferromagnetic layer 6 having high kinetic energy when heat treatment is performed are diffused toward the surface of the capping layer 20 by the coupling force with oxygen in air. Accordingly, the quantity of Mn atoms diffused into the second ferromagnetic layer 5 is relatively small. Thus, the deterioration of a magnetic feature caused as the Mn atoms of the antiferromagnetic layer 6 are diffused into the second ferromagnetic layer 5 is remarkably prevented. In addition, the Mn atoms diffused toward the surface of the capping layer 20 are coupled to oxygen at the surface of the capping layer 20 to constitute a stable Mn oxide. Since the surface of the capping layer 20 is very even as described above, a specular scattering phenomenon that spin conduction electrons scattered when a magnetic field is applied from a magnetic recording medium and proceeding toward the Mn oxide are reflected toward the second ferromagnetic layer 5 from the even surface of the capping layer 20 is generated. Accordingly, a mean free path of the spin conduction electrons increases and spin dependent scattering increases, so that the magnetoresistive ratio increases.

In the case of the first sample in which the capping layer 7 is formed of a Ta material having large surface energy and a high degree of surface coarseness, the specular scattering phenomenon as above does not occur so that the magnetoresistive ratio is lowered compared to the second sample. Also, unlike the amorphous CoNbZr alloy of the second sample, since Ta of the first sample has a strong coupling force with oxygen, a stable Ta oxide is formed at the surface portion of the capping layer 7 formed of a Ta material at the time when Mn atoms are diffused by a high temperature. Also, the Mn atoms are prevented from being diffused toward the surface of the capping layer 7 by the stable Ta oxide. As a result, most Mn atoms in the first sample are diffused toward the second ferromagnetic layer 5 to lower the magnetoresistive ratio.

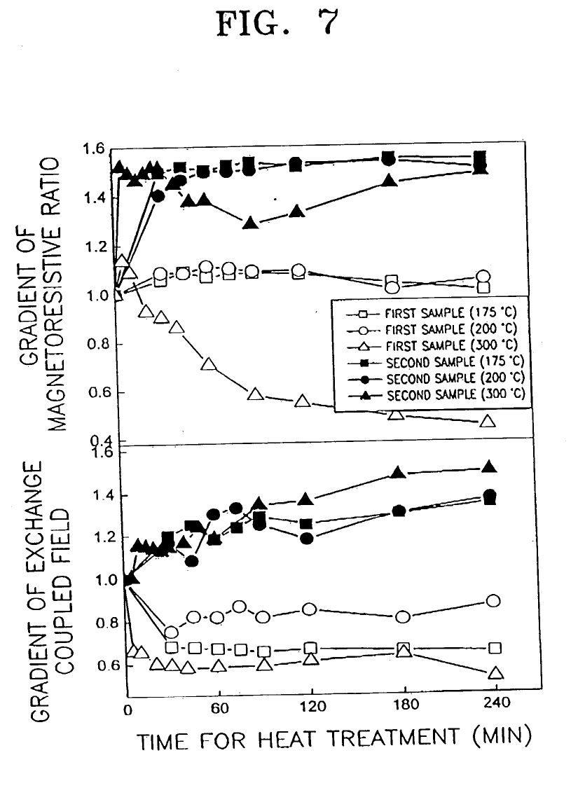

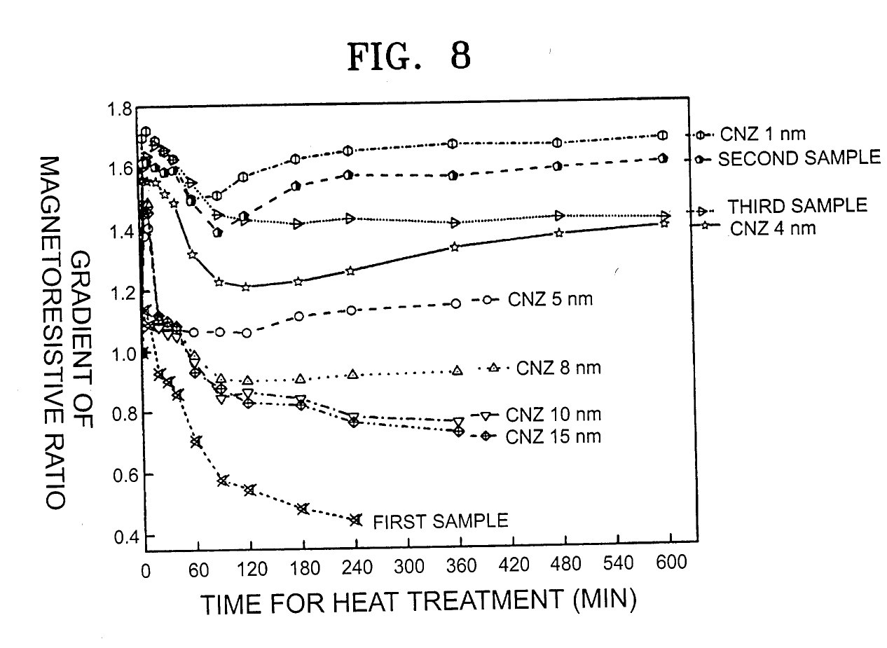

The subject inventor conducted experiments like the above-described experiments at a heat treatment temperature of 175° C. and 200° C. to each of the first and second samples. The gradient of the magnetoresistive ratio and the exchange coupling field after heat treatment to those before heat treatment for each of the first and second samples is shown in FIG. 7.

As shown in FIG. 7, it can be seen that, in the case of the first sample, although the magnetoresistive ratio increases after heat treatment is performed at temperatures of 175° C. and 200° C., the amount of increment is very small while the exchange coupled field is drastically reduced. In particular, it can be seen that both magnetoresistive ratio and exchange coupling field are remarkably reduced during the heat treatment process at a temperature of 300° C. For example, the magnetoresistive ratio and the exchange coupling field of the first sample which is heat-treated at a temperature of 300° C. for 240 minutes are reduced by about 0.5 times, respectively, compared to those of the first sample before the heat treatment.

In the meantime, in the case of the second sample, the magnetoresistive ratio and the exchange coupling field are sharply increased during the heat treatment process at the respective temperatures. For example, in the case of the second samples which are heat-treated at a temperature of 175° C. or more for a long time of 240 minutes, the magnetoresistive ratio is increased by about 1.5 times compared to that of each of the second samples before the heat treatment while the exchange coupled field is increased by about 1.3-1.5 times compared to that of each of the second samples before the heat treatment.

Thus, the structure according to the present invention in which the under layer and the capping layer are formed of an amorphous CoNbZr alloy can provide very superior thermal stability compared to the conventional structure in which the under layer and the capping layer are formed of a Ta material.

To obtain the effect by the capping layer, the subject inventor manufactured samples (CNZ 1 nm) having 1 nm thickness of the capping layer 20 formed of a CoNbZr alloy, samples (CNZ 4 nm) having 4 nm thickness of the capping layer 20, samples (CNZ 5 nm) having 5 nm thickness of the capping layer 20, samples (CNZ 8 nm) having 8 nm thickness of the capping layer 20, samples (CNZ 10 nm) having 10 nm thickness of the capping layer 20, and samples (CNZ 15 nm) having 15 nm thickness of the capping layer 20, while the other structure is the same as that of the second sample. Also, a sample (a third sample) in which only the capping layer is not formed while the other structure is the same as second sample is manufactured. Heat treatment at a temperature of 300° C. for a long time over 360 minutes is performed to each of the above samples and the gradient of the magnetoresistive ratio after heat treatment with respect to the magnetoresistive ratio before heat treatment is shown in FIG. 8.

As can be seen from FIG. 8, in the case of the samples (CNZ1 nm, the second sample, CNZ 4 nm, and CNZ 5 nm) in which the thickness of the capping layer 20 formed of amorphous CoNbZr alloy is less than or equal to 5 nm, the magnetoresistive ratio increases after heat treatment. In the case of the samples (CNZ 8 nm, CNZ 10 nm, and CNZ 15 nm) in which the thickness of the capping layer 20 is greater than or equal to 8 nm, the magnetoresistive ratio decreases after heat treatment, but it can be seen that they exhibit superior thermal stability compared to the first sample.

In the meantime, in the case of the third sample which has only the under layer 10 formed of a CoNbZr alloy but does not have the capping layer, the magnetoresistive ratio after heat treatment increases by about 1.4 times. The third sample is quite thermally stable compared to the first sample having the under layer 2 and the capping layer 7 formed of a Ta material. The main reason is that the interdiffusion and the intermixing of the atoms in each layer are reduced because the boundary surface of each of the layers above the under layer 10 is evenly formed by the under layer 10 formed of an amorphous CoNbZr alloy having an even surface. Also, since most Mn atoms of the antiferromagnetic layer 6 are diffused toward the surface of the antiferromagnetic layer 6 to be coupled with oxygen in air, the reduction of a magnetic feature cased by the diffusion of the Mn atoms toward the second ferromagnetic layer 5 is effectively reduced. Further, the Mn atoms diffused toward the surface of the antiferromagnetic layer 6 are coupled with oxygen in air to form a Mn oxide on the surface of the antiferromagnetic layer 6, so that the spin dependent scattering increases, which becomes a factor to increase the magnetoresistive ratio. Accordingly, it can be seen from the experiments on the third sample that a superior thermal stability can be obtained by having the under layer 10 only formed of an amorphous CoNbZr alloy without provision of the capping layer.

It is obvious that the present invention is not limited to the above-described structure according to a preferred embodiment and the present invention can be applied to a spin valve type magnetoresistive element having a different deposition structure. For example, the present invention can be adopted in various spin value type magnetoresistive element such as a magnetoresistive element in which a sensor portion is formed in order of an antiferromagnetic layer, a second ferromagnetic layer, a spacer layer, and a first ferromagnetic layer, or a magnetoresistive element having a pair of antiferromagnetic layers, a pair of second ferromagnetic layers, and a pair of spacer layers, by forming a sensor portion above the under layer in order of an antiferromagnetic layer, a second ferromagnetic layer, a spacer layer, a first ferromagnetic layer, a spacer layer, a second ferromagnetic layer, and an antiferromagnetic layer.

Also, in the magnetoresistive element of the present preferred embodiment, although it is described that the first ferromagnetic layer 3 and the second ferromagnetic layer 5 are formed of an CoFe alloy, the spacer layer 4 is formed of Cu, and the antiferromagnetic layer 6 is formed of an IrMn alloy, it is obvious to form the first ferromagnetic layer 3, the spacer layer 4, the second ferromagnetic layer 5, and the antiferromagnetic layer 6 with other well-known materials. When the capping layer 20 formed of a CoNbZr alloy is provided, the antiferromagnetic layer 6 is preferably formed of an alloy including Mn such as an IrMn alloy, a FeMn alloy, or NiMn alloy, to obtain a specular scattering effect by an Mn oxide as described above.

As described above, the spin valve type magnetoresistive element according to the present invention, since the under layer where the sensor portion is sequentially deposited is formed of an amorphous CoNbZr alloy, even when the magnetoresistive element is heated at a high temperature, the major features such as a magnetoresistive ratio or the exchange coupled field are not much deteriorated. Furthermore, the major features can be improved so that a superior thermal stability is achieved.

What is claimed is:

1. A spin valve type magnetoresistive element comprising:
a substrate;
an under layer deposited on the substrate, the under layer being formed of an amorphous CoNbZr alloy; and
a sensor portion arranged on the under layer, the sensor portion comprising:
a first ferromagnetic layer in which a magnetizing direction is changed by application of a magnetic field;
a second ferromagnetic layer in which a magnetizing direction is fixed;
a spacer layer which is non-magnetic and arranged between the first ferromagnetic layer and the second ferromagnetic layer; and
an antiferromagnetic layer which is arranged to be adjacent to the second ferromagnetic layer to fix the magnetizing direction of the second ferromagnetic layer.

2. The spin valve type magnetoresistive element as claimed in claim 1, further comprising a capping layer which is deposited on the antiferromagnetic layer and formed of an amorphous CoNbZr alloy, and wherein the antiferromagnetic layer is formed of an alloy including Mn.
